(19) United States
(12) Patent Application Publication
(10) Pub. No.: US 2022/0309130 A1
(43) Pub. Date: Sep. 29, 2022

(54) GAMING LICENSE PRIORITIZATION BASED ON CLIENT DEVICE

(71) Applicant: IGT, Las Vegas, NV (US)

(72) Inventors: David Froy, JR., New Brunswick (CA); David Small, New Brunswick (CA)

(21) Appl. No.: 17/215,943

(22) Filed: Mar. 29, 2021

(51) Int. Cl. G06F 21/10; G07F 17/32

(52) U.S. Cl. CPC G06F 21/10; G07F 17/323; G07F 17/3241; G06F 2221/2109

(57) ABSTRACT

Systems and methods that prioritize gaming establishment license usages based on types of client devices.

### BACKGROUND

In various embodiments, the present disclosure pertains to prioritizing one type of client device to be associated with a license to play a game over another type of client device.

Gaming machines may provide players awards in primary games. Gaming machines generally require the player to place a wager to activate the primary game. The award may be based on the player obtaining a winning symbol or symbol combination and on the amount of the wager.

### BRIEF SUMMARY

In certain embodiments, the present disclosure relates to a system including a processor, and a memory device that stores a plurality of instructions. When executed by the processor responsive to receipt of a first game license request from an electronic gaming machine and receipt of a second game license request from a mobile device, the instructions cause the processor to determine a quantity of game licenses available to be granted. When executed by the processor responsive to the determined quantity of game licenses available to be granted being one game license, the instructions cause the processor to grant the first game license request of the electronic gaming machine, and deny the second game license request of the mobile device. When executed by the processor responsive to the determined quantity of game licenses available to be granted being greater than one game license, the instructions cause the processor to grant the first game license request of the electronic gaming machine, and grant the second game license request of the mobile device.

In certain embodiments, the present disclosure relates to a system including a processor, and a memory device that stores a plurality of instructions. When executed by the processor responsive to receipt of a game license request from an electronic gaming machine and a determination that no game licenses are available to be granted, the instructions cause the processor to determine if any mobile devices are associated with any game licenses. When executed by the processor responsive to the determination being that a mobile device is associated with a game license, the instructions cause the processor to disassociate the game license from being associated with the mobile device, and grant the game license request of the electronic gaming machine.

In certain embodiments, the present disclosure relates to a system including a processor, and a memory device that stores a plurality of instructions. When executed by the processor responsive to receipt of a first transfer request from a mobile device to an electronic gaming machine, the instructions cause the processor to disassociate a game license from being associated with the mobile device, and associate the game license with the electronic gaming machine. When executed by the processor responsive to receipt of a second transfer request from the electronic gaming machine to the mobile device and a determination that another game license is available for another electronic gaming machine, the instructions cause the processor to disassociate the game license from being associated with the electronic gaming machine, and associate the game license with the mobile device.

Additional features are described herein, and will be apparent from the following Detailed Description and the figures.

### BRIEF DESCRIPTION OF THE FIGURES

FIG. 1 is an example configuration of the architecture of a plurality of different components of the system of the present disclosure

FIGS. 2A and 2B (collectively FIG. 2) are a flow chart of an example process of one embodiment of the present disclosure illustrating the granting of a game license based on the priority of a client device.

FIG. 3 is a schematic block diagram of one embodiment of an electronic configuration of an example electronic gaming machine of the system of the present disclosure.

FIGS. 4A and 4B are perspective views of example alternative embodiments of an example electronic gaming machine of the system of the present disclosure.

FIG. 4C is a front view of an example personal gaming device of the system of the present disclosure.

### DETAILED DESCRIPTION

In various embodiments, the systems and methods of the present disclosure prioritizes the granting of a request for a game license (e.g., a license or token that enables a client device to offer a play of a game) based on the different types of client devices requesting such game licenses.

In certain embodiments wherein a gaming entity is associated with a quantity of game licenses which define a maximum quantity of client devices permitted to play one or more games associated with that gaming entity at a point in time, upon a client device requesting to be granted assignment of such a game license, the system determines, based on one or more factors, whether or not to grant the requested game license to the client device on a temporary basis. In these embodiments, based on the demand of client devices associated with a gaming entity at any specific point in time potentially exceeding the supply of game licenses available to grant to such client devices at that specific point in time, the system of the present disclosure determines, based on one or more factors associated with, amongst others, the client device, a user of the client device, and/or anticipated game license demand, which client devices are temporary associated with such game licenses (and which client devices need to wait for another game license to become available for that client device to be temporary associated with that other game license).

In certain embodiments, the determination of whether or not to grant a requested game license is based on a quantity of unassigned game licenses, and one or more characteristics of the requesting client device. For example, if an electronic gaming machine (“EGM”), such as a slot machine (which qualifies as a first type of client device) and a personal gaming device, such as a mobile device executing a mobile device application operable to provide a play of a game (which qualifies as a second type of client device) each request to be assigned to a game license and the system determines that there are not enough unassigned game licenses to grant both requests, the system determines that granting the request of the EGM takes precedent over granting the request of the personal gaming device and assigns the game license to the EGM (while not assigning the game license to the personal gaming device). In this example, the system prioritizes one type of client device (e.g., an EGM) over another type of client device (e.g., a personal gaming device) to ensure that any game licenses available to enable a user to play a game, such as a wagering game, are directed to or otherwise employed for certain types of client devices over other types of client devices to maintain user expectations of such devices.

In certain embodiments, the determination of whether or not to grant a requested game license is alternatively or additionally based on a location of the requesting client device. For example, if a personal gaming device located at a first venue requests to be assigned to a game license and the system determines that at least one EGM at a second venue is not currently assigned a game license, the system assigns the game license to the personal gaming device at the first venue. It should be appreciated that in this example, since the system prioritizes the granting of game licenses to EGMs over the granting of game licenses to personal gaming devices, if an EGM at the second venue subsequently requests a game license and the system determines that there are no more available unassigned game licenses to grant the request of the EGM, the system reassigns the game license from the personal gaming device at the first venue to the EGM at the second venue. Such a reassignment of a game license from a personal gaming device to an EGM encourages the player using the personal gaming device to utilize an EGM at the first venue to play one or more games.

As such and in view of the different client devices available for users to access to play one or more games that require a license to play, the system of the present disclosure prioritizes certain client devices over other client devices to ensure that preferred client devices are granted first access to game licenses. Such a configuration of managing game licenses for different client devices across different venues further ensures that a non-preferred client device at one venue may still be assigned a game license from another venue if that other venue has one or more available game licenses. Additionally, such a configuration of centralizing the management of game licenses for different client devices across different venues increases operational efficiencies of the system by better ensuring that game license demand at one venue is satisfied using game license supply from another venue which reduces unnecessary client device idle time.

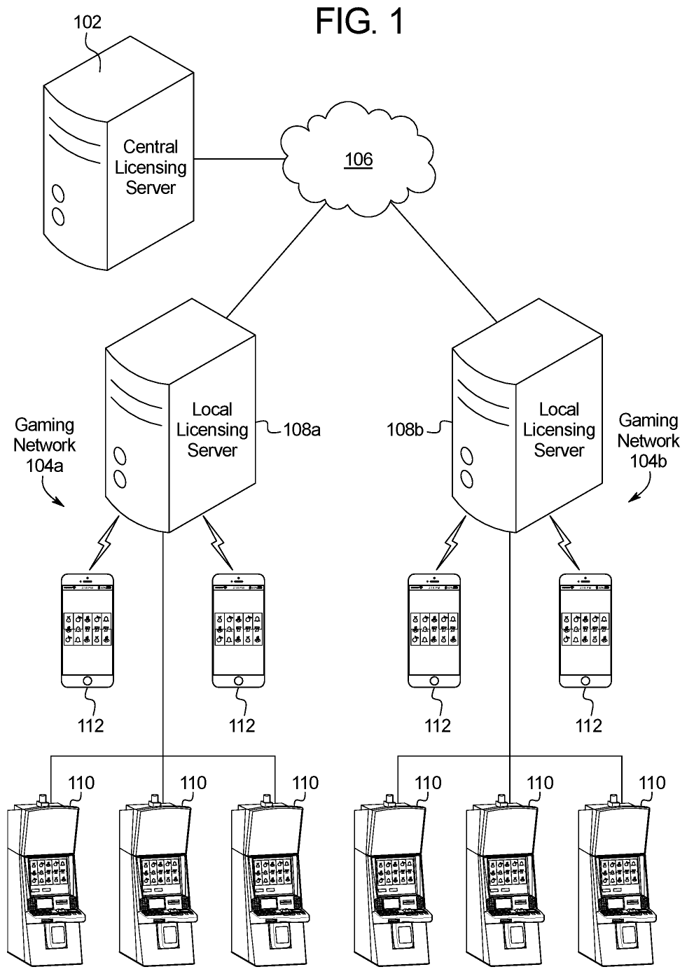

In certain embodiments, the system of the present disclosure includes various components that operate with each other to grant and deny game licenses to zero, one or more client devices associated with such components. For example, as seen in FIG. 1, the system includes a central licensing server 102 which maintains, in a central licensing database (not shown) a plurality of game licenses associated with a gaming entity. The central licensing server 102 also maintains a queue of client devices requesting game licenses and utilizes such a queue to determine whether to grant or deny each instance of a requested game license.

In certain embodiments, each game license provides a client device currently associated with that game license the opportunity to offer one or more games, such as wagering games of chance and/or wagering games of skill. In certain such embodiments, each game license provides a client device currently associated with that game license the opportunity to offer a plurality of different games such that a game license is not associated with any particular game. In certain other embodiments, each game license provides a client device currently associated with that game license the opportunity to offer a specific game and not offer other games. In certain embodiments, each game license additionally or alternatively provides a client device currently associated with that game license the opportunity to place one or more sporting event wagers on one or more outcomes of one or more sporting events. In certain such embodiments, each game license provides a client device currently associated with that game license the opportunity to offer a plurality of different sporting event wagers such that a game license is not associated with any particular sporting event or sporting event wager. In certain other embodiments, each game license provides a client device currently associated with that game license the opportunity to offer a specific sporting event wager and not offer other sporting event wagers.

As further seen in FIG. 1, the central licensing server 102 is in communication with one or more local gaming network 104a and 104b via a network 106, such as the Internet, a virtual private network, a local area network, a wide area network or any other suitable network. Each local gaming network 104 includes a local licensing server 108a and 108b in communication with a plurality of client devices such as EGMs 110 and personal gaming devices 112 located in a gaming establishment venue and/or located remote from the gaming establishment venue but otherwise associated with the gaming establishment venue. It should be appreciated that an EGM in communication with one or more local licensing servers and/or the central licensing server includes any suitable electronic gaming machine, such as, but not limited to, a slot machine, a video poker machine, a video lottery terminal, a terminal associated with an electronic table game, a terminal associated with a game played at a gaming table, a video keno machine, a video bingo machine and/or a sports betting terminal (that offers sports betting opportunities and, in certain instances, wagering games). It should be further appreciated that a personal gaming device in communication with one or more local licensing servers and/or the central licensing server includes any suitable personal gaming device such as, but not limited to, a user's mobile device executing a mobile device application (e.g., a player's mobile phone), a gaming establishment mobile device executing a mobile device application (e.g., a casino tablet computer), a desktop computer, a laptop computer, and/or a personal digital assistant. In certain embodiments, the mobile device application is a location based digital wallet enabled application, such as a Passbook-enabled or Wallet-enabled application, which enables the personal gaming device to be associated with an available game license when the personal gaming device enters a gaming establishment venue (or is otherwise associated with a location associated with the gaming establishment venue). In certain such embodiments, the mobile device application is downloaded to the mobile device from an application store regardless of the user being located in or otherwise associated with a gaming establishment venue. In certain other embodiments, the mobile device application is downloaded to the mobile device from one or more websites or application stores affiliated with the gaming establishment venue (which are accessible directly by the user and/or by a link opened when the user scans a QR code associated with the gaming establishment venue) regardless of the user being located in or otherwise associated with a gaming establishment venue.

While illustrated as each local gaming network including a local licensing server, in different embodiments, each local gaming network may include (and the client devices of that local gaming network may be in communication with) a plurality of local licensing servers, a plurality of local gaming networks may collectively include (and the client devices of those local gaming networks may be in communication with) a single local licensing server or a plurality of local gaming networks may share one or more local licensing servers. Additionally, while illustrated as the system including a single central licensing server, in different embodiments, the system includes a plurality of central licensing servers or the system does not include any central licensing servers (and one or more local licensing servers individually or collectively perform one or more of the tasks attributed to the central licensing server).

In different embodiments, the EGMs communicatively connect to and communicate data with the central licensing server, the local licensing server and/or any component of a gaming establishment management system via any suitable data network such as a virtual private network, a local area network, a wide area network or any other suitable network. In different embodiments, the EGMs and/or personal gaming devices communicatively connect to and communicate data with the central licensing server, the local licensing server and/or any component of a gaming establishment management system via any suitable wireless communication protocol, including, but not limited to: Bluetooth™, Bluetooth™ Low Energy (“BLE”), one or more cellular communication standards (e.g., 3G, 4G, 5G, LTE), one or more Wi-Fi compatible standards, and one or more short range communication protocols (e.g., a near field communication (“NFC”) protocol).

As described in more detail below, the central licensing server and/or the local licensing server each performs zero, one or more licensing functions, such as game license validations, game license monitoring, game license updating and/or game license authorizations. In different embodiments, the game license operations of the central licensing server and/or the game license operations of the local licensing server each ranges from minimal game license responsibilities to full-scale game license services depending on the absence or presence of other components in the system tasked with responsibility for such licensing functions.

In various embodiments, the plurality of game licenses maintained in the central licensing database represent the maximum quantity of client devices associated with a gaming entity that may be actively engaged by users. For example, if 1,000 game licenses are granted to a gaming entity in a gaming jurisdiction and the 1,000 game licenses are maintained in the central licensing database in association with that gaming jurisdiction, then up to 1,000 client devices associated with the gaming entity in the gaming jurisdiction may, at any one point in time, offer access provided by such game licenses. In certain embodiments, in addition to the central licensing database maintaining a quantity of game licenses corresponding to the maximum number of active client devices that are associated with a gaming entity for a gaming jurisdiction, the system allocates each gaming establishment venue associated with that gaming entity a quantity of the maximum quantity of client devices associated with the gaming entity that may be actively engaged by users. Continuing with this example, if the gaming entity in the gaming jurisdiction is associated with two gaming establishment venues that will equally share the game licenses, then a first of the gaming establishment venues is allocated 500 game licenses and a second of the gaming establishment venues is allocated 500 game licenses. In this example, while each gaming establishment venue is allocated a quantity of game licenses, the actual number of game licenses in use by each gaming establishment venue will vary based on the needs of the different gaming networks in the system and the priorities of the client devices requesting such game licenses. It should be appreciated that in different embodiments, a gaming entity in a gaming jurisdiction (which is associated with zero, one or more central licensing servers and zero, one or more local licensing servers) includes one or more corporate entities and the various children entities (i.e., zero, one or more gaming establishment brands and zero, one or more gaming establishment venues having one or more EGMs and/or being associated with one or more personal gaming devices) that are associated with such corporate entities. In different embodiments, a gaming establishment venue includes one or more properties where a client device may operate (or may operate in association with), a gaming establishment brand includes a group of gaming establishment venues under one or more brands, and a corporate entity includes a group of gaming establishment brands and/or a group of gaming establishment venues.

In certain embodiments, each game license maintained in the central licensing database is stored in association with a uniquely assigned identification, such as stored as an access license token assigned an identifier. In certain embodiments, each game license maintained in the central licensing database that is currently assigned to a client device is additionally or alternatively stored in association with an expiry time stamp, such as stored as an access license token associated with an expiration time and/or a time period until expiration. In certain embodiments, each game license maintained in the central licensing database is additionally or alternatively stored in association with a priority value, such as stored as an access license token associated with a priority value which determines, at least in part, which client device may be associated with that access license token. In certain embodiments, for each game license maintained in the central licensing database that is currently associated with a client device, the central licensing database additionally or alternatively stores an identification of the client device currently associated with that game license.

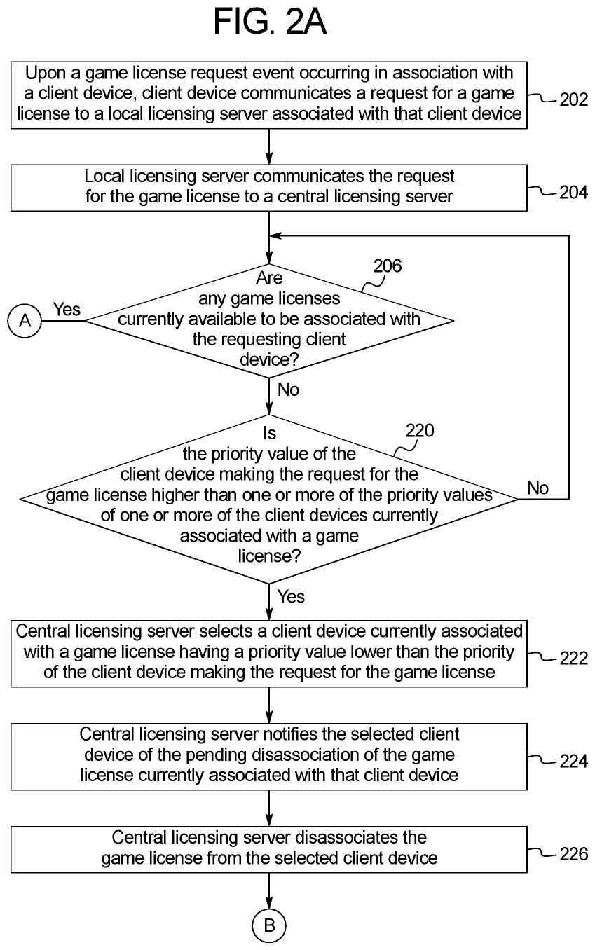

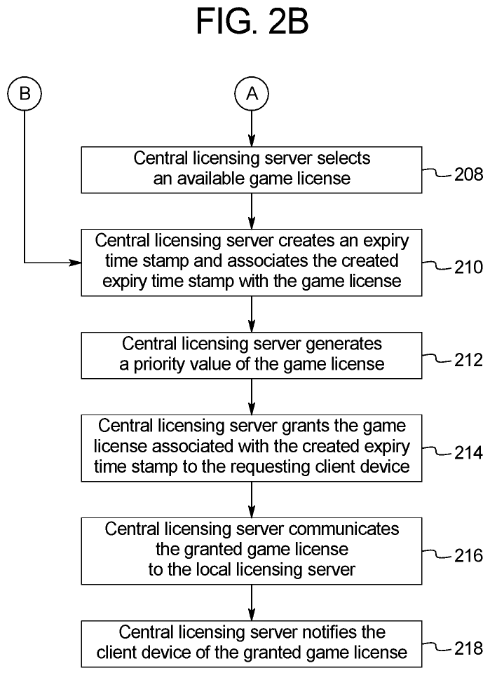

FIG. 2 is a flowchart of an example of the processes or methods of operating the system of the present disclosure. In various embodiments, the processes are represented by a set of instructions stored in one or more memories and executed by one or more processors. Although the processes are described with reference to the flowchart shown in FIG. 2, many other processes of performing the acts associated with these illustrated processes may be employed. For example, the order of certain of the illustrated blocks or diamonds may be changed, certain of the illustrated blocks or diamonds may be optional, or certain of the illustrated blocks or diamonds may not be employed.

In various embodiments, upon a game license request event occurring in association with a client device, the client device communicates a request for a game license to the local licensing server associated with that client device as indicted in block 202. In these embodiments, an idle client device, such as an inactive EGM, is not associated or otherwise assigned a game license and requires a game license to be at least temporarily associated or otherwise assigned to the client device to enable the client device to offer certain features, such as one or more plays of one or more games.

In certain embodiments, the request for the game license is associated with information about the client device, such as one or more of an identification of the client device (e.g., an identifier associated with an EGM or an identifier associated with a mobile device/a mobile device application), the type of client device (i.e., an EGM or a mobile device), a location of the client device (i.e., on premises at a gaming establishment venue or remote from the gaming establishment venue), a game license request history of the client device (i.e., how frequently and when has the client device made requests for game licenses), a type of game associated with the client device (e.g., does the client device request a license for a poker game or a keno game), an amount of funds associated with the client device, an average expected payback percentage of the paytable of the game associated with the client device, and/or the denomination of the game to be played using the client device. In certain embodiments, the request for the game license is additionally or alternatively associated with information about the player currently engaging the client device, such as one or more of an identity of the player currently engaging the client device, a status of the player currently engaging the client device (e.g., a player tracking status of the player), a wagering history of the player currently engaging the client device, and/or an amount of funds currently in one or more gaming establishment accounts maintained for the player.

In certain embodiments, a game license request event occurs in association with a client device upon a player initially engaging the client device. In one such embodiment, a game license request event occurs in association with a client device upon a funding of a credit balance of the client device, such as a player inserting or otherwise transferring money to an EGM or a player designating an amount of funds in a gaming establishment account associated with the player, such as a cashless wagering account, as available for use in association with a personal gaming device. In another such embodiment, a game license request event occurs in association with a client device upon a player logging into a gaming establishment system, such as a player tracking system or a cashless wagering system, from the client device. In another such embodiment, a game license request event occurs in association with a client device upon one or more inputs received by the client device indicating that the player would like to commence a gaming session at the client device. In another such embodiment, a game license request event occurs in association with a client device upon one or more inputs received by the client device indicating that the player would like to commence a play of a game at the client device.

In certain embodiments, a game license request event occurs in association with a client device following the client device being disassociated from a game license, such as upon a previous game license assigned to the client device expiring or a previous game license assigned to the client device being reassigned to another client device. In one such embodiment, a game license request event automatically occurs in association with a client device following a game license associated with that client device being reassigned to another client device and another game license becoming available. In another such embodiment, a game license request event occurs in association with a client device upon one or more inputs received by the client device indicating that the player would like to continue a previous gaming session at the client device. In another such embodiment, a game license request event occurs in association with a client device upon one or more inputs received by the client device indicating that the player would like to commence another play of a game at the client device.

In the example embodiment of FIG. 2, following the local licensing server receiving the request for a game license from the client device, the local licensing server communicates the request for the game license to the central licensing server as indicated in block 204. In certain other embodiments, such as an embodiment wherein the central licensing server is in communication with the client device with or without the employment of any local licensing servers, rather than the client device communicating the request for a game license to the local licensing server, the client device communicates the request for a game license to the central licensing server.

Following the central licensing server receiving the game license request from a client device, the central licensing server determines whether any game licenses are currently available to be associated with the requesting client device as indicated in diamond 206. In these embodiments, since the central licensing server maintains the central licensing database of each of the game licenses associated with a gaming entity and since the central licensing database includes, for each of the game licenses, whether that game license is or is not currently associated with a client device, the central licensing server employs the central licensing database to determine whether or not the requested game license may be granted based on an available game license.

In certain embodiments, the central licensing server determines whether any game licenses are currently available to be associated with the requesting client device based on the total quantity of game licenses maintained in the central licensing database and the current status of such game licenses. In certain such embodiments, such a determination is made on a system-wide basis by determining whether or not the quantity of game licenses available to the gaming entity are currently in use independent of if such game licenses are allocated to one gaming establishment venue or another gaming establishment venue. In certain such embodiments, even if each of the game licenses allocated to the local licensing server associated with the requesting client device are currently associated with a client device, if the central licensing server determines that another game license allocated to another local licensing server not associated with the requesting client device has one or more game licenses available, the central licensing server will determine that a game license is available for the requesting client device. For example, if: (i) each of the game licenses associated with a first local licensing server are currently associated with EGMs of a relatively busy gaming establishment venue, (ii) a quantity of the game licenses associated with a second local licensing server are not currently associated with EGMs of a relatively empty gaming establishment venue, and (iii) the requesting client device is a personal gaming device in communication with the first local licensing server, then the central licensing server determines that a game license allocated to the relatively empty gaming establishment venue is available for the personal gaming device in communication with the first local licensing server.

In certain embodiments, the central licensing server determines whether any game licenses are currently available to be associated with the requesting client device based on the game licenses allocated to the local licensing server associated with the requesting client device and the current status of such game licenses. In certain such embodiments, such a determination is made on a gaming establishment venue by gaming establishment venue basis by determining whether or not the quantity of game licenses allocated to the local licensing server associated with the requesting client device are currently in use. In these embodiments, if each of the game licenses allocated to the local licensing server associated with the requesting client device are currently associated with a client device, the central licensing server will determine that a game license is not available for the requesting client device regardless of if another game license allocated to another local licensing server not associated with the requesting client device has one or more game licenses available. For example, if: (i) each of the game licenses associated with a first local licensing server are currently associated with EGMs of a relatively busy gaming establishment venue, and (ii) the requesting client device is a personal gaming device in communication with the first local licensing server, the central licensing server determines that a game license is not available even if a quantity of the game licenses associated with a second local licensing server are not currently associated with EGMs of a relatively empty gaming establishment venue.

In addition to the central licensing server determining whether any game licenses are currently available to be associated with the requesting client device, in certain embodiments, the central licensing server updates a queue of client devices making requests for available game licenses. In these embodiments, the queue of client devices includes a time stamp of when the request was made, a priority value of the client device (determined as described below in relation to determining a priority value to be associated with a selected available game license) and a unique identification of the client device. Such a queue is sortable based on the time stamps of the different requests made and/or the priority values of the different client devices requesting game licenses.

If the central licensing server determines that at least one game license is available for the client device, the central licensing server selects an available game license as indicated in block 208. In these embodiments, the central licensing server accesses the central licensing database and determines, based on the statuses of one or more game licenses, an available game license to select to be temporarily associated with (or otherwise assigned to) the requesting client device.

Following the identification of a game license for the client device, the central licensing server then creates an expiry time stamp and associates the created expiry time stamp with the game license as indicated in block 210. Such an expiry time stamp is associated with an amount of time that game license may be employed in association with the client device before being designated as available again.

In certain embodiments, each expiry time stamp is associated with the same amount of time until expiration. In certain other embodiments, different expiry time stamps are associated with different amounts of time until expiration. In certain embodiments, the expiry time stamp created is based on one or more attributes of the client device requesting the game license. For example, if the system prioritizes granting game licenses to EGMs over granting game licenses to personal gaming devices, if the requesting client device is an EGM, the central licensing server creates a first expiry time stamp associated with a first amount of time that the game license may be employed in association with the EGM until expiration and if the requesting client device is a personal gaming device, the central licensing server creates a second expiry time stamp associated with a second, lesser amount of time that the game license may be employed in association with the personal gaming device until expiration.

In certain embodiments, the expiry time stamp created is based on one or more attributes of the player at the client device requesting the game license. For example, if the system prioritizes granting game licenses to players with player tracking statuses over granting game licenses to players without any player tracking status (e.g., anonymous players), if a first player with a first player tracking status is associated with the requesting client device, the central licensing server creates a first expiry time stamp associated with a first amount of time that the game license may be employed in association with the client device until expiration and if a second player without any player tracking status is associated with the requesting client device, the central licensing server creates a second expiry time stamp associated with a second, lesser amount of time that the game license may be employed in association with the client device until expiration.

In certain embodiments, the expiry time stamp created is based on one or more factors associated with the gaming establishment venue, such as a time of the day, a current occupancy of the gaming establishment venue, a historical occupancy of the gaming establishment venue and/or an anticipated occupancy of the gaming establishment venue (which, in certain instances, employs an artificial intelligence agent that learns how to accurately forecast occupancy of a gaming establishment venue relative to available game licenses). For example, during a first period of time when the central licensing server anticipates, based on historical game license usage rates, a relative small amount of demand for game licenses, the central licensing server creates a first expiry time stamp associated with a first amount of time that the game license may be employed in association with the client device until expiration and during a second period of time when the central licensing server anticipates, based on historical game license usage rates, a relative higher amount of demand for game licenses, the central licensing server creates a second expiry time stamp associated with a second, lesser amount of time that the game license may be employed in association with the client device until expiration.

Following the creation of an expiry time stamp and the association of the created expiry time stamp, the central licensing server generates a priority value of the game license as indicated in block 212. In these embodiments, since the demand for game licenses available may exceed the supply for game licenses available at certain points in time requiring a redistribution of which client devices are granted game licenses and which client devices are denied game licenses, the system determines a priority value for each game license associated with a client device (or in the process of being associated with a client device) wherein the determined priority value factors into any redistribution of such game licenses.

In certain embodiments, the determined priority value is based on one or more attributes of the client device requesting the game license. In these embodiments, the system accounts for one or more aspects or characteristics of the client device requesting the game license in determining the priority value for the selected game license.

In certain embodiments, the determined priority value is based on the type of the client device requesting the game license. For example, if the system prioritizes granting game licenses to EGMs over granting game licenses to personal gaming devices, if the requesting client device is an EGM, the central licensing server generates a first priority value to be associated with the selected game license and if the requesting client device is a personal gaming device, the central licensing server generates a second, lower priority value to be associated with the selected game license. In another example, if the system prioritizes granting game licenses to certain types of EGMs, such as slot machines, over granting game licenses to other types of EGMs, such as keno machines, if the requesting client device is a slot machine, the central licensing server generates a first priority value to be associated with the selected game license and if the requesting client device is a keno machine, the central licensing server generates a second, lower priority value to be associated with the selected game license.

In certain embodiments, the determined priority value is additionally or alternatively based on the denomination associated with the client device requesting the game license. For example, if the system prioritizes granting game licenses to client devices employing relatively higher denominations of wagers placed over granting game licenses to client devices having relatively lower denominations of wagers placed, if the requesting client device has a first, relatively high denomination, the central licensing server generates a first priority value to be associated with the selected game license and if the requesting client device has a second, relatively low denomination, the central licensing server generates a second, lower priority value to be associated with the selected game license.

In certain embodiments, the determined priority value is additionally or alternatively based on the maximum wager amount available for the game associated with the client device requesting the game license. For example, if the system prioritizes granting game licenses to client devices employing games having higher maximum wager amounts over granting game licenses to client devices employing games having lower maximum wager amounts, if the game of the requesting client device has a first maximum wager amount, the central licensing server generates a first priority value to be associated with the selected game license and if the game of the requesting client device has a second, lower maximum wager amount, the central licensing server generates a second, lower priority value to be associated with the selected game license.

In certain embodiments, the determined priority value is additionally or alternatively based on the type of game associated with the client device requesting the game license. For example, if the system prioritizes granting game licenses to client devices associated with a first type of game over granting game licenses to client devices associated with a second, different type of game, if the requesting client device is associated with the first type of game, the central licensing server generates a first priority value to be associated with the selected game license and if the requesting client device is associated with a second, different type of game, the central licensing server generates a second, lower priority value to be associated with the selected game license. It should be appreciated that one or more of the client devices which are temporarily assigned one or more game licenses are associated with any suitable game that may be played by a player currently associated with the client device including any wagering game and/or any social or casual game such as, but not limited to: any suitable slot game; any suitable wheel game; any suitable card game; any suitable offer and acceptance game; any suitable award ladder game; any suitable puzzle-type game; any suitable persistence game; any suitable selection game; any suitable cascading symbols game; any suitable ways to win game; a play of any suitable scatter pay game; any suitable coin-pusher game; any suitable elimination game; any suitable stacked wilds game; any suitable trail game; any suitable bingo game; any suitable video scratch-off game; any suitable pick-until-complete game; any suitable shooting simulation game; any suitable racing game; any suitable promotional game; any suitable high-low game; any suitable lottery game; any suitable number selection game; any suitable dice game; any suitable skill game; any suitable matching game; any suitable augmented reality game; any suitable auction game; any suitable reverse-auction game; and/or any suitable group game.

In certain embodiments, the determined priority value is additionally or alternatively based on an average expected payback percentage of the paytable associated with the game associated with the client device requesting the game license. For example, if the system prioritizes granting game licenses to client devices employing games associated with paytables having relatively higher average expected payback percentages over granting game licenses to client devices employing games associated with paytables having relatively lower average expected payback percentages, if the game of the requesting client device is associated with a first average expected payback percentage, the central licensing server generates a first priority value to be associated with the selected game license and if the game of the requesting client device is associated with a second, higher average expected payback percentage, the central licensing server generates a second, lower priority value to be associated with the selected game license.

In certain embodiments, the determined priority value is additionally or alternatively based on a location of the client device requesting the game license. For example, if the system prioritizes granting game licenses to client devices located at a first gaming establishment venue (as determined via one or more geolocation modules of the client device) over granting game licenses to client devices located at a second gaming establishment venue, if the requesting client device is located within the first gaming establishment venue, the central licensing server generates a first priority value to be associated with the selected game license and if the requesting client device is located at the second the gaming establishment venue, the central licensing server generates a second, lower priority value to be associated with the selected game license.

In certain embodiments, the determined priority value is additionally or alternatively based on a location of the client device requesting the game license relative to a gaming establishment venue. For example, if the system prioritizes granting game licenses to client devices located within a gaming establishment venue (as determined via one or more geolocation modules of the client device) over granting game licenses to client devices located remote from a gaming establishment venue, if the requesting client device is located within a gaming establishment venue, the central licensing server generates a first priority value to be associated with the selected game license and if the requesting client device is located remote from the gaming establishment venue, the central licensing server generates a second, lower priority value to be associated with the selected game license. In another example, if the system prioritizes granting game licenses to client devices located remote from a gaming establishment venue (as determined via one or more geolocation modules of the client device) over granting game licenses to client devices located within a gaming establishment venue, if the requesting client device is located remote from a gaming establishment venue, the central licensing server generates a first priority value to be associated with the selected game license and if the requesting client device is located within the gaming establishment venue, the central licensing server generates a second, lower priority value to be associated with the selected game license.

In certain embodiments, the determined priority value is additionally or alternatively based on a current occupancy rate of the gaming establishment venue. In certain embodiments, the determined priority value is additionally or alternatively based on an anticipated occupancy rate of the gaming establishment venue, such as an anticipated occupancy rate determined based on an artificial intelligence agent and historical occupancy rates of the gaming establishment venue.

In certain embodiments, the determined priority value is additionally or alternatively based on a frequency of game license requests associated with the client device requesting the game license. In one such embodiment, the system prioritizes granting game licenses to client devices that request game licenses relatively less frequently over granting game licenses to client devices that request game licenses relatively more frequently. In another such embodiment, the system prioritizes granting game licenses to client devices that request game licenses relatively more frequently over granting game licenses to client devices that request game licenses relatively less frequently.

In certain embodiments, the determined priority value is additionally or alternatively based on an amount of time since the client device last requested a game license. In one such embodiment, the system prioritizes granting game licenses to client devices with a relatively longer duration since a last request for a game license over granting game licenses to client devices with a relatively shorter duration since a last request for a game license. In another such embodiment, the system prioritizes granting game licenses to client devices with a relatively shorter duration since a last request for a game license over granting game licenses to client devices with a relatively longer duration since a last request for a game license.

In certain embodiments, the determined priority value is additionally or alternatively based on a current credit balance associated with the client device requesting the game license. In one such embodiment, the system prioritizes granting game licenses to client devices with relatively higher credit balances over granting game licenses to client devices with relatively lower credit balances. In another such embodiment, the system prioritizes granting game licenses to client devices with relatively lower credit balances over granting game licenses to client devices with relatively higher credit balances.

In certain embodiments, the determined priority value is additionally or alternatively based on one or more attributes of the player currently associated with the client device requesting the game license. In these embodiments, the system accounts for one or more aspects or characteristics of the player engaging the client device requesting the game license in determining the priority value for the selected game license.

In certain embodiments, the determined priority value is based on an identification of the player currently associated with the client device requesting the game license. For example, if the system prioritizes granting game licenses to identified players over granting game licenses to anonymous players, if the player currently associated with the requesting client device is an identified player, such as a player identified through a player tracking system, the central licensing server generates a first priority value to be associated with the selected game license and if the player currently associated with the requesting client device is an unidentified player, the central licensing server generates a second, lower priority value to be associated with the selected game license. In another example, if the system prioritizes granting game licenses to players having relatively higher player tracking statuses over granting game licenses to players having relatively lower player tracking statuses, if the player currently associated with the requesting client device has a first player tracking status, the central licensing server generates a first priority value to be associated with the selected game license and if the player currently associated with the requesting client device has a second, lower player tracking status, the central licensing server generates a second, lower priority value to be associated with the selected game license.

In certain embodiments, the determined priority value is based on an amount of funds maintained in a gaming establishment account associated with the player currently associated with the client device requesting the game license. For example, if the system prioritizes granting game licenses to players with relatively more funds maintained in a gaming establishment account, such as a cashless wagering account, over granting game licenses to players with relatively less funds maintained in a gaming establishment account, such as a cashless wagering account, if the player currently associated with the requesting client device has a first amount of funds in a gaming establishment account, the central licensing server generates a first priority value to be associated with the selected game license and if the player currently associated with the requesting client device has a second, lower amount of funds in a gaming establishment account, the central licensing server generates a second, lower priority value to be associated with the selected game license. In another example, if the system prioritizes granting game licenses to players with relatively less funds maintained in a gaming establishment account, such as a cashless wagering account, over granting game licenses to players with relatively more funds maintained in a gaming establishment account, such as a cashless wagering account, if the player currently associated with the requesting client device has a first amount of funds in a gaming establishment account, the central licensing server generates a first priority value to be associated with the selected game license and if the player currently associated with the requesting client device has a second, higher amount of funds in a gaming establishment account, the central licensing server generates a second, lower priority value to be associated with the selected game license.

In certain embodiments, the determined priority value is additionally or alternatively based on one or more attributes that are independent of the player currently associated with the client device requesting the game license and independent of the client device requesting the game license. In these embodiments, the system accounts for one or more non-player, non-client device aspects or characteristics in determining the priority value for the selected game license. For example, the determined priority value is based on a time of the day, and/or a day of the week.

It should be appreciated that the determined priority value for the selected game license is, in certain embodiments, based on a combination of one or more factors. For example, if the system prioritizes granting game licenses to EGMs over granting game licenses to personal gaming devices and the system also prioritizes granting game licenses to players having relatively higher player tracking statuses over granting game licenses to players having relatively lower player tracking statuses, if the requesting client device is an EGM currently associated with a player having a first player tracking status, the central licensing server generates a first priority value to be associated with the selected game license and if the requesting client device is a personal gaming device currently associated with a player having a second, higher player tracking status, the central licensing server generates a second, higher priority value to be associated with the selected game license.

Following the generation of a priority value for the game license, the central licensing server grants the game license associated with the created expiry time stamp to the requesting client device as indicated in block 214. The central licensing server then communicates the granted game license to the local licensing server which notifies the client device of the granted game license as indicated in block 216 and 218. In certain embodiments, in association with the granting of the game license, the central licensing server updates the central licensing database to designate that the selected game license is currently unavailable and is associated with the identified client device. In certain embodiments, the central licensing server also updates the queue of client devices making requests to designate that the request is satisfied.

Following such granting of the game license, the client device may partake in activities associated with the game license so long as the client device remains associated with the game license. In these embodiments, upon an expiration of the amount of time which the game license is granted to the client device (and assuming that the game license is not otherwise disassociated from the client device and reassociated to another client device), the game license is disassociated from the client device and again becomes an available game license. That is, upon a determination that a game license currently associated with a client device has expired, the game license is disassociated from the client device by the local licensing server and reported to the central licensing server as available to be associated with another client device (or the same client device).

In certain embodiments, the local licensing server and the client device periodically communicate messages to each other indicating that the game license is still in use by the client device. In such embodiments, if a client device is disconnected from the gaming network before the expiry time stamp has expired, the system will assign a temporary expiry time stamp to the client device awaiting the client device to reconnect to the gaming network. In certain embodiments, while the temporary expiry time is elapsing awaiting a reconnection, the actual expiry time stamp is paused to enable the client device to resume game play and continue with the time assigned to the client device upon a reconnection to the gaming network. In these embodiments, once the client device can reconnect and if the gaming session was still in progress and if the existing game license has not expired, the existing game license will be reassigned to the client device and game play will continue.

Referring back to FIG. 2, if the central licensing server determines that no game licenses are available for the client device, the central licensing server determines if the priority value of the client device making the request for the game license is higher than one or more of the priority values of one or more of the client devices currently associated with a game license as indicated in diamond 220. Put differently, if there are no game licenses left in the pool of available game licenses maintained by the central licensing system, then the central licensing system will look at the priority value of the client device making a request relative to the landscape of which client devices are currently associated with game licenses and the respective priority values of such client devices.

If the central licensing server determines that the priority value of the client device making the request for the game license is lower than the priority values of the client devices currently associated with game licenses, the central licensing server returns to diamond 206 and again determines whether any game licenses are currently available to be associated with the requesting client device. In these embodiments, if the central licensing server determines that the priority value of the requesting client device does not warrant redistributing a game license from another client device to that requesting client device, the central licensing server awaits for another game license to become available. For example, upon the central licensing server determining that the requesting client device is a personal gaming device associated with a first priority value and the central licensing server further determining that the game licenses currently associated with client devices are each associated with EGMs having second, higher priority values, the central licensing server determines that the personal gaming device needs to wait for another game license to become available. In this example, based on the priority to grant game licenses to EGMs over personal gaming devices, if the demand for game licenses exceeds the supply of game licenses, the system will ensure that game licenses currently assigned to EGMs remain with EGMs and such personal gaming devices will need to wait until the supply of game licenses exceeds the demand for game licenses and another game license becomes available. In one such embodiment, another game license becomes available upon another player of another client device terminating a gaming session and that other client device returning the game license associated with that client device. In another such embodiment, another game license becomes available upon the expiration of the amount of time associated with that other game license, wherein upon such an expiration, the client device associated with that other game licenses returns the game license.

On the other hand, if the central licensing server determines that the priority value of the client device making the request for the game license is higher than the priority value of one or more of the client devices currently associated with a game license, the central licensing server selects a client device currently associated with a game license having a priority value lower than the priority value of the client device making the request for the game license as indicted in block 222. In these embodiments, if the central licensing server determines that the priority value of the requesting client device warrants redistributing a game license from another client device to that requesting client device, the central licensing server identifies another client device that will need to give up a currently associated game license. For example, upon the central licensing server determining that the requesting client device is an EGM associated with a first priority value and the central licensing server further determining that at least one game license is currently associated with at least one personal gaming device having a second, lower priority value, the central licensing server determines that the game license currently associated with the personal gaming device needs to be reassigned to being associated with the requesting EGM. In this example, based on the priority to grant game licenses to EGMs over personal gaming devices, if the demand for game licenses exceeds the supply of game licenses, the system will ensure that game licenses currently assigned to personal gaming devices will need to be redistributed to EGMs to maintain the priority configuration of the system.

In certain embodiments, following the selection of a client device currently associated with a game license having a priority value lower than the priority value of the client device making the request for the game license, the central licensing server notifies the selected client device (either directly or through the local licensing server) of the pending disassociation of the game license currently associated with that client device as indicated in block 224. In these embodiment, upon receiving such a notification, the selected client device informs the player of that client device that the current game session will end in a predetermined amount of time, such as providing the player a one-minute warning of when the gaming session will conclude. In these embodiments, in addition to informing the player of the termination of the gaming session (and in certain embodiments informing the player of when another game license becomes available), the system saves the state of play of the gaming session such that when the selected client device becomes associated with another game license, the selected client device can resume the gaming session from where the player left off. For example, upon a personal gaming device being notified that the game license currently associated with that personal gaming device is being reassigned to another client device, an application being executed by that personal gaming device informs the player that the current gaming session will conclude in a minute and further saves (or operates with the central licensing server, the local licensing server and/or another component of the system to save) the game state information such that upon another game license becoming available for the personal gaming device, the player may resume the gaming session.

In certain embodiments, following the notification of the selected client device of the pending disassociation of the game license currently associated with that client device and upon an expiration of any predetermined amount of time until such a disassociation, the central licensing server disassociates the game license from the selected client device as indicated in block 226 and proceeds with creating an expiry time stamp and associating the created expiry time stamp with that game license as indicated in block 210. In these embodiments, the system operates to transfer a game license from one client device to another client upon an occurrence of a transfer event, such as upon a determination that the priority values of such client devices warrant such a transfer. In certain embodiments, the disassociation of a game license from one client device and the ensuing association of that game license to another client device operates the same as if the disassociated/reassociated game license was initially available. In certain other embodiments, following the notification of the selected client device of the pending disassociation of the game license currently associated with that client device, the central licensing server disassociates the game license from the selected client device and reassociates that game license to the higher priority client device while maintaining the attributes (e.g., the previously created expiry time stamp) of that game license.

Accordingly and in view of the different client devices available for users to access to play one or more games that require a license to play, the system of the present disclosure prioritizes certain client devices over other client devices to ensure that preferred client devices are granted first access to game licenses. Such a configuration of managing game licenses for different client devices across different venues further ensures that a non-preferred client device at one venue may still be assigned a game license from another venue if that other venue has one or more available game licenses. Additionally, such a configuration of centralizing the management of game licenses for different client devices across different venues (which, in certain embodiments, employs artificial intelligence to prioritize and assign game licenses for different types of client devices) increases operational efficiencies of the system by better ensuring that game license demand at one venue is satisfied using game license supply from another venue which reduces unnecessary client device idle time.

It should thus be appreciated that the present disclosure provides for the real time management of available game licenses by the central licensing server (that in certain instances is visualized to players via notifications communicated to players at client devices) including the real time assignment, activation and removal of game licenses to individual client devices, such as EGM and personal gaming devices. Such a configuration enables the central licensing server to manage the employment of game licenses for multiple local licensing servers from various gaming establishment venues to ensure adequate coverage for all gaming establishment venues across multiple systems from various vendors. For example, if the demand for a specific game at a first gaming establishment venue exceeds the supply of game licenses for that specific game, the system is operable to provide players real time access to that specific game via personal gaming devices (either gaming establishment provided or player provided) wherein such game licenses are temporarily repurposed from being allocated to that first gaming establishment venue from a second gaming establishment venue where the supply of game licenses for the specific game exceeds the current demand to play that specific game. In this example, through the redistribution of game licenses associated with specific games, the system is operable to proactively advise the players that such a specific game is available for play on a personal gaming device even if each of the EGMs associated with that specific game in the first gaming establishment venue are currently occupied by other players. In another example, to expand the universe of players participating in a gaming tournament at a gaming establishment venue where each of the allocated game licenses for that gaming tournament are currently associated with EGMs, the system enables the temporary association of additional game licenses to personal gaming devices wherein such additional game licenses are from under-utilized gaming establishment venues and/or from unused game licenses associated with other games within the same gaming establishment venue. In this example, the expansion of the number of players participating in a gaming tournament via the redistribution of game licenses enables more players the opportunity to win more awards in such a gaming tournament. Accordingly, the system of the present disclosure manages game licenses across multiple gaming establishment venues associated with multiple types of client devices to attempt to equate the supply and demand for such game licenses based on the ever changing circumstances of such gaming establishment venues.

In certain embodiments, the system of the present disclosure enables two or more client devices to share a single game license. In these embodiments, when two client devices are connected to the central licensing system and each request a game license, if there are not enough game licenses available (or if an operator of the system prefers that more client devices are granted game licenses than game licenses allocated to the system), the system enables the sharing of game licenses. In operation, upon two client devices each requesting a game license as described above and the system determining that such client devices will share a game license, the system associates a unique identification for each client device sharing the game license and further communicates to each client device a flag notifying the client device of the sharing of the game license. In these embodiments, when a player at a client device makes an input to play a game, such as spin the reels of a client device, that client device will send a request for play access to the local licensing server. The local licensing server will forward the request to the central licensing server which locks the game license. Once locked the central licensing server will send a request to the client device enabling it to play the game, such as spin the reels and generate an outcome. Once the outcome is generated and sent to that client device, the central licensing server unlocks the game license. In these embodiments, if the second client device tries to send a request to be associated with the game license while the game license is locked in association with the first client device, the second client device will wait until the game license is unlocked before the system locks the game license in association with the second client device. Conversely, once the game license is locked in association with the second client device, the first client device will then have to wait for the second client device to release the game license before the first client device may generate a new outcome. In this way there is only ever one client device actively using or otherwise associated with the game license at a time.

It should be appreciated that the above-described embodiments may be implemented in accordance with or in conjunction with one or more of a variety of different types of systems, such as, but not limited to, those described below. As such, the present disclosure contemplates a variety of different systems each having one or more of a plurality of different features, attributes, or characteristics. A “system” or “gaming system” as used herein refers to various configurations of: (a) one or more servers; (b) one or more electronic gaming machines such as those located on a casino floor; and/or (c) one or more personal gaming devices. Thus, in various embodiments, the system of the present disclosure includes: (a) one or more electronic gaming machines in combination with one or more servers; (b) one or more personal gaming devices in combination with one or more servers; (c) one or more personal gaming devices in combination with one or more electronic gaming machines; (d) one or more personal gaming devices, one or more electronic gaming machines, and one or more servers in combination with one another; (e) a single electronic gaming machine; (f) a plurality of electronic gaming machines in combination with one another; (g) a single personal gaming device; (h) a plurality of personal gaming devices in combination with one another; (i) a single server; and/or (j) a plurality of servers in combination with one another. For brevity and clarity and unless specifically stated otherwise, “EGM” as used herein represents one EGM or a plurality of EGMs, “personal gaming device” as used herein represents one personal gaming device or a plurality of personal gaming devices, and “server” as used herein represents one server or a plurality of servers.

As noted above, in various embodiments, the system includes an EGM (or personal gaming device) in combination with a server. In such embodiments, the EGM (or personal gaming device) is configured to communicate with the server through a data network or remote communication link. In certain such embodiments, the EGM (or personal gaming device) is configured to communicate with another EGM (or personal gaming device) through the same data network or remote communication link or through a different data network or remote communication link. For example, the system includes a plurality of EGMs that are each configured to communicate with a server through a data network. In certain embodiments in which the system includes an EGM (or personal gaming device) in combination with a server, the server is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the server. The at least one processor of that EGM (or personal gaming device) is configured to execute the events, messages, or commands represented by such data or signals in conjunction with the operation of the EGM (or personal gaming device). Moreover, the at least one processor of the server is configured to transmit and receive data or signals representing events, messages, commands, or any other suitable information between the server and the EGM (or personal gaming device). The at least one processor of the server is configured to execute the events, messages, or commands represented by such data or signals in conjunction with the operation of the server. One, more than one, or each of the functions of the server may be performed by the at least one processor of the EGM (or personal gaming device). Further, one, more than one, or each of the functions of the at least one processor of the EGM (or personal gaming device) may be performed by the at least one processor of the server.

In certain such embodiments, computerized instructions for controlling any games (such as any primary or base games and/or any secondary or bonus games) displayed by the EGM (or personal gaming device) are executed by the server. In such “thin client” embodiments, the server remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the server to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the system includes an EGM (or personal gaming device) and a server, computerized instructions for controlling any primary or base games displayed by the EGM (or personal gaming device) are communicated from the server to the EGM (or personal gaming device) in a thick client configuration, and computerized instructions for controlling any secondary or bonus games or other functions displayed by the EGM (or personal gaming device) are executed by the server in a thin client configuration.

In certain embodiments in which the system includes: (a) an EGM (or personal gaming device) configured to communicate with a server through a data network; and/or (b) a plurality of EGMs (or personal gaming devices) configured to communicate with one another through a data network, the data network is a local area network (LAN) in which the EGMs (or personal gaming devices) are located substantially proximate to one another and/or the server. In one example, the EGMs (or personal gaming devices) and the server are located in a gaming establishment or a portion of a gaming establishment.

In other embodiments in which the system includes: (a) an EGM (or personal gaming device) configured to communicate with a server through a data network; and/or (b) a plurality of EGMs (or personal gaming devices) configured to communicate with one another through a data network, the data network is a wide area network (WAN) in which one or more of the EGMs (or personal gaming devices) are not necessarily located substantially proximate to another one of the EGMs (or personal gaming devices) and/or the server. For example, one or more of the EGMs (or personal gaming devices) are located: (a) in an area of a gaming establishment different from an area of the gaming establishment in which the server is located; or (b) in a gaming establishment different from the gaming establishment in which the server is located. In another example, the server is not located within a gaming establishment in which the EGMs (or personal gaming devices) are located. In certain embodiments in which the data network is a WAN, the system includes a server and an EGM (or personal gaming device) each located in a different gaming establishment in a same geographic area, such as a same city or a same state. Systems in which the data network is a WAN are substantially identical to systems in which the data network is a LAN, though the quantity of EGMs (or personal gaming devices) in such systems may vary relative to one another.

In further embodiments in which the system includes: (a) an EGM (or personal gaming device) configured to communicate with a server through a data network; and/or (b) a plurality of EGMs (or personal gaming devices) configured to communicate with one another through a data network, the data network is an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the server identifies a player before enabling that player to place any wagers on any plays of any wagering games. In one example, the server identifies the player by requiring a player account of the player to be logged into via an input of a unique username and password combination assigned to the player. The server may, however, identify the player in any other suitable manner, such as by validating a player tracking identification number associated with the player; by reading a player tracking card or other smart card inserted into a card reader (as described below); by validating a unique player identification number associated with the player by the server; or by identifying the EGM (or personal gaming device), such as by identifying the MAC address or the IP address of the Internet facilitator. In various embodiments, once the server identifies the player, the server enables placement of one or more wagers on one or more plays of one or more primary or base games and/or one or more secondary or bonus games, and displays those plays via the Internet browser of the EGM (or personal gaming device).

The server and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

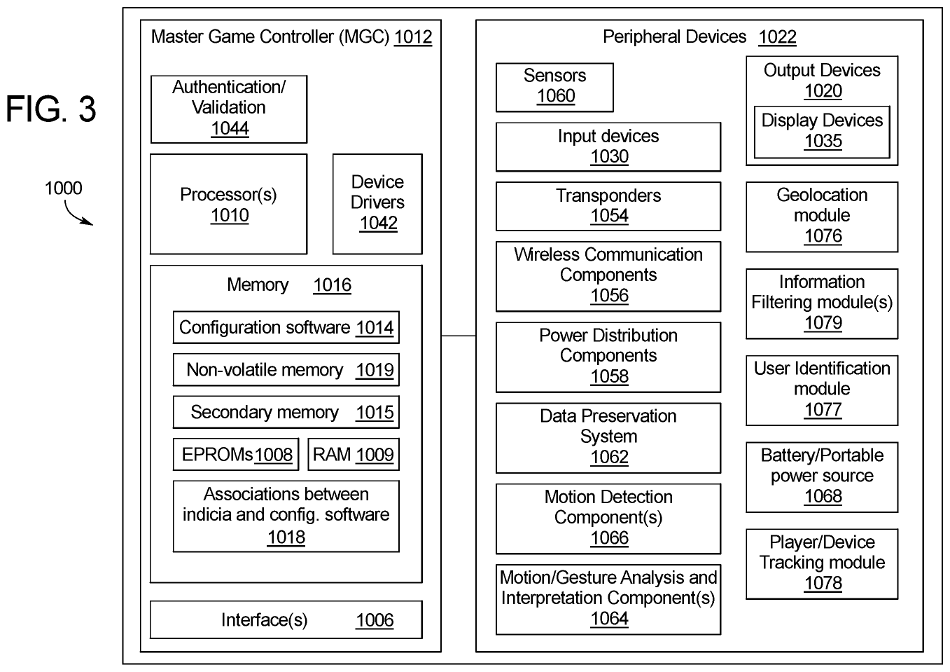

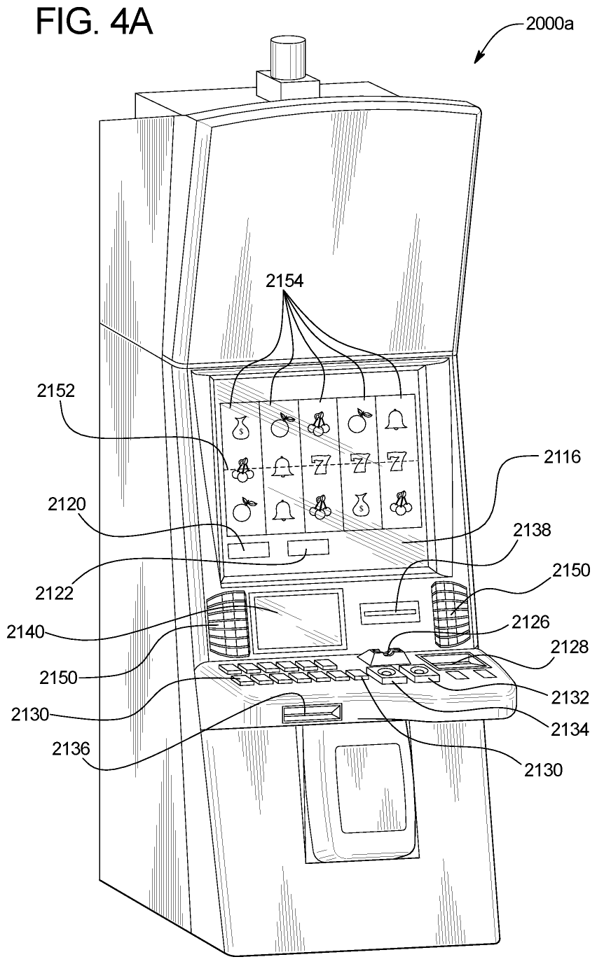

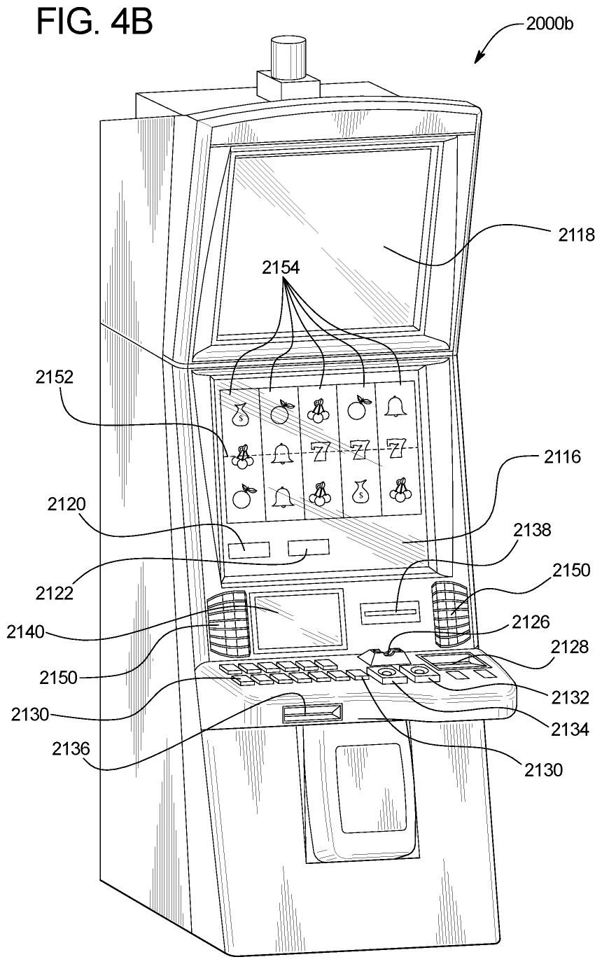

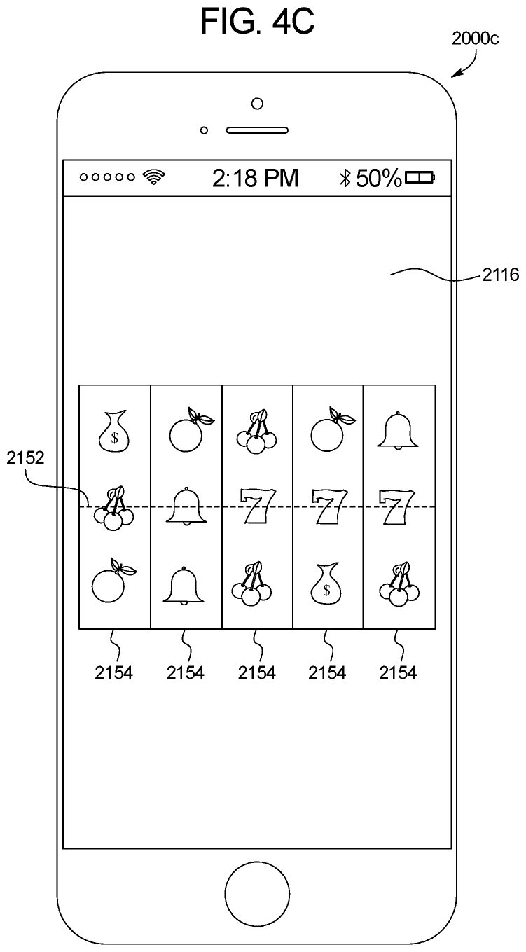

FIG. 3 is a block diagram of an example EGM 1000 and FIGS. 4A and 4B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 4C) may include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game conditions in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM of the present disclosure. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the conditions and settings for a game playable on the EGM; (2) associations 1018 between configuration indicia read from an EGM with one or more conditions and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new conditions, new settings for existing conditions, new settings for new conditions, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, conditions, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, conditions, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 4A includes a central display device 2116, a player tracking display 2140, a credit display 2120, and a bet display 2122. The example EGM 2000b illustrated in FIG. 4B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 4A and 4B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 4A and 4B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 4A and 4B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 4A and 4B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 4A and 4B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 4A and 4B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 4A and 4B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 4A and 4B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 4A and 4B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all systems, and these example EGMs may not include one or more elements that are included in other systems. For example, certain EGMs include a coin acceptor while others do not.

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the system includes a server and a changeable EGM, the at least one memory device of the server stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the server is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the server to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request. The gaming system provides the selected game outcome and/or award.

In certain embodiments, the gaming system determines a predetermined game outcome and/or award based on the results of a bingo, keno, or lottery game. In certain such embodiments, the gaming system utilizes one or more bingo, keno, or lottery games to determine the predetermined game outcome and/or award provided for a primary game and/or a secondary game. The gaming system is provided or associated with a bingo card. Each bingo card consists of a matrix or array of elements, wherein each element is designated with separate indicia. After a bingo card is provided, the gaming system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the gaming system includes a server and an EGM, the EGM is configured to communicate with the server for monitoring purposes only. In such embodiments, the EGM determines the game outcome(s) and/or award(s) to be provided in any of the manners described above, and the server monitors the activities and events occurring on the EGM. In one such embodiment, the gaming system includes a real-time or online accounting and gaming information system configured to communicate with the server. In this embodiment, the accounting and gaming information system includes: (a) a player database configured to store player profiles, (b) a player tracking module configured to track players (as described below), and (c) a credit system configured to provide automated transactions.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming system. In certain such embodiments, the gaming system includes one or more paylines associated with the reels. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The gaming system enables a wager to be placed on one or more of such paylines to activate such paylines. In other embodiments in which one or more paylines are formed between at least two adjacent symbol display areas, the gaming system enables a wager to be placed on a plurality of symbol display areas, which activates those symbol display areas.

In various embodiments, the gaming system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the gaming system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the system includes one or more player tracking systems. Such player tracking systems enable operators of the system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the system to begin a gaming session, the card reader reads the player identification number off the player tracking card to identify the player. The system timely tracks any suitable information or data relating to the identified player's gaming session. The system also timely tracks when the player tracking card is removed to conclude play for that gaming session. In another embodiment, rather than requiring insertion of a player tracking card into the card reader, the system utilizes one or more portable devices, such as a mobile phone, a radio frequency identification tag, or any other suitable wireless device, to track when a gaming session begins and ends. In another embodiment, the system utilizes any suitable biometric technology or ticket technology to track when a gaming session begins and ends.

In such embodiments, during one or more gaming sessions, the system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the system includes one or more servers configured to communicate with a personal gaming device—such as a smartphone, a tablet computer, a desktop computer, or a laptop computer—to enable web-based game play using the personal gaming device. In various embodiments, the player must first access a gaming website via an Internet browser of the personal gaming device or execute an application (commonly called an “app”) installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player's unique username and password combination, providing an input to a biometric sensor (e.g., a fingerprint sensor, a retinal sensor, a voice sensor, or a facial-recognition sensor), or providing any other suitable information.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player's account balance. In other embodiments, the one or more servers enable the player to make a payment using the player's credit card, debit card, or other suitable device to add money to the player's account balance. In other embodiments, the one or more servers enable the player to add money to the player's account balance via a peer-to-peer type application, such as PayPal or Venmo. The one or more servers also enable the player to cash out the player's account balance (or part of it) in any suitable manner, such as via an electronic funds transfer, by initiating creation of a paper check that is mailed to the player, or by initiating printing of a voucher at a kiosk in a gaming establishment.

In certain embodiments, the one or more servers include a payment server that handles establishing and cashing out players' account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player's account balance can cover the desired wager (i.e., includes a monetary balance at least equal to the desired wager).

If the payment server determines that the player's account balance cannot cover the desired wager, the payment server notifies the game server, which then instructs the personal gaming device to display a suitable notification to the player that the player's account balance is too low to place the desired wager. If the payment server determines that the player's account balance can cover the desired wager, the payment server deducts the desired wager from the account balance and notifies the game server. The game server then determines an outcome and any associated award for the play of the game. The game server notifies the payment server of any nonzero award, and the payment server increases the player's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines or within the boundaries of a gaming establishment). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the system includes an EGM configured to communicate with a personal gaming device—such as a smartphone, a tablet computer, a desktop computer, or a laptop computer—to enable tethered mobile game play using the personal gaming device. Generally, in these embodiments, the EGM establishes communication with the personal gaming device and enables the player to play games on the EGM remotely via the personal gaming device. In certain embodiments, the system includes a geo-fence system that enables tethered game play within a particular geographic area but not outside of that geographic area.

In certain embodiments, the system is configured to communicate with a social network server that hosts or partially hosts a social networking website via a data network (such as the Internet) to integrate a player's gaming experience with the player's social networking account. This enables the system to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the system to receive certain information from the social network server, such as the player's likes or dislikes or the player's list of connections. In certain embodiments, the system enables the player to link the player's player account to the player's social networking account(s). This enables the system to, once it identifies the player and initiates a gaming session (such as via the player logging in to a website (or an application) on the player's personal gaming device or via the player inserting the player's player tracking card into an EGM), link that gaming session to the player's social networking account(s). In other embodiments, the system enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the system sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the system sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the system sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the system enables the player to recommend a game to the player's connections by posting a recommendation to the player's wall (or other suitable area) of the social networking website.

Certain of the gaming systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention claimed is:

1. A system comprising:
a processor; and
a memory device that stores a plurality of instructions that, when executed by the processor, cause the processor to:
responsive to receipt of a first game license request from an electronic gaming machine and receipt of a second game license request from a mobile device:
determine a quantity of game licenses available to be granted,
responsive to the determined quantity of game licenses available to be granted being one game license:
grant the first game license request of the electronic gaming machine, and
deny the second game license request of the mobile device, and
responsive to the determined quantity of game licenses available to be granted being greater than one game license:
grant the first game license request of the electronic gaming machine, and
grant the second game license request of the mobile device.

2. The system of claim 1, wherein the electronic gaming machine is associated with a first gaming venue and the mobile device is associated with a second, different gaming venue.

3. The system of claim 1, wherein the electronic gaming machine is associated with a gaming venue and the mobile device is not associated with any gaming venue.

4. The system of claim 1, wherein the electronic gaming machine is associated with a first gaming venue and the one game license is associated with a second, different gaming venue.

5. The system of claim 1, wherein when executed by the processor responsive to the receipt of the second game license request from the mobile device, no receipt of the first game license request from the electronic gaming machine and the determined quantity of game licenses available to be granted being the one game license, the instructions cause the processor to grant the second game license request of the mobile device.

6. The system of claim 1, wherein the determination of the quantity of game licenses available to be granted is based on a forecast of game licenses available.

7. A system comprising:
a processor; and
a memory device that stores a plurality of instructions that, when executed by the processor responsive to receipt of a game license request from an electronic gaming machine and a determination that no game licenses are available to be granted, cause the processor to:
determine if any mobile devices are associated with any game licenses, and
responsive to the determination being that a mobile device is associated with a game license:
disassociate the game license from being associated with the mobile device, and
grant the game license request of the electronic gaming machine.

8. The system of claim 7, wherein when executed by the processor responsive to the determination being that the mobile device is associated with the game license, the instructions cause the processor to disassociate the game license from being associated with the mobile device after a predetermined period of time.

9. The system of claim 8, wherein when executed by the processor responsive to the determination being that the mobile device is associated with the game license, the instructions cause the processor to communicate data to the mobile device that results in the mobile device displaying a disconnection message prior to a conclusion of the predetermined period of time.

10. The system of claim 8, wherein when executed by the processor responsive to a determination that another game license becomes available, the instructions cause the processor to communicate data to the mobile device that results in the mobile device displaying a resume message.

11. The system of claim 7, wherein the electronic gaming machine is associated with a first gaming venue and the mobile device is associated with a second, different gaming venue.

12. The system of claim 7, wherein the electronic gaming machine is associated with a gaming venue and the mobile device is not associated with any gaming venue.

13. The system of claim 7, wherein the electronic gaming machine is associated with a first gaming venue and the game license is associated with a second, different gaming venue.

14. A system comprising:
a processor; and
a memory device that stores a plurality of instructions that, when executed by the processor, cause the processor to:
responsive to receipt of a first transfer request from a mobile device to an electronic gaming machine:
disassociate a game license from being associated with the mobile device, and
associate the game license with the electronic gaming machine, and
responsive to receipt of a second transfer request from the electronic gaming machine to the mobile device and a determination that another game license is available for another electronic gaming machine:
disassociate the game license from being associated with the electronic gaming machine, and
associate the game license with the mobile device.

15. The system of claim 14, wherein when executed by the processor responsive to the receipt of the second transfer request from the electronic gaming machine to the mobile device and a determination that the other game license is unavailable for the other electronic gaming machine:
disassociate the game license from being associated with the electronic gaming machine, and
associate the game license with the other electronic gaming machine.

16. The system of claim 14, wherein when executed by the processor responsive to the receipt of the first transfer request from the mobile device to the electronic gaming machine, the instructions cause the processor to cause a transfer of any of game state data and funding data from the mobile device to the electronic gaming machine.

17. The system of claim 14, wherein when executed by the processor responsive to the receipt of the second transfer request from the electronic gaming machine to the mobile device and the determination being that the other game license is available for the other electronic gaming machine, the instructions cause the processor to cause a transfer of any of game state data and funding data from the electronic gaming machine to the mobile device.

18. The system of claim 14, wherein the electronic gaming machine is associated with a first gaming venue and the mobile device is associated with a second, different gaming venue.

19. The system of claim 14, wherein the electronic gaming machine is associated with a gaming venue and the mobile device not associated with any gaming venue.

20. The system of claim 14, wherein the electronic gaming machine is associated with a first gaming venue and the game license is associated with a second, different gaming venue.
